(19) United States
(12) Patent Application Publication
(10) Pub. No.: US 2001/0043265 A1
(43) Pub. Date: Nov. 22, 2001

(54) Method and apparatus for displaying flicker free stereoscopic images on a display device

(76) Inventors: Kenneth Tetterington, Edmonton (CA); Nan Liu, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 09/681,640

(22) Filed: May 15, 2001

Related U.S. Application Data
(60) Provisional application No. 60/204,124, filed on May 15, 2000.

(51) Int. Cl. H04N 13/04; H04N 15/00; H04N 9/47

(52) U.S. Cl. 348/51; 348/53

(57) ABSTRACT

5A method and apparatus for displaying flicker free stereoscopic images on a television monitor whereby Shutter Glasses alternate at three times faster than the refresh rate of display device, including the formatting required to view stereoscopic perspective images on the display device.

### CROSS REFERENCE TO RELATED APPLICATIONS

This application claims the priority benefit under 35 U.S.C. 119(e) of U.S. Provisional Application No. 60/204,124 filed on May 15, 2000 as Attorney Docket No. 45162.3.

### BACKGROUND OF INVENTION

The present invention relates to a method and apparatus for displaying stereoscopic images on a display device without apparent flicker.

In order for a viewer to see stereoscopic images it is necessary for each of the viewers eyes to view the subject matter from a slightly different perspective such that each eye sees a different view of the image. Several methods are currently used to display stereoscopic images on a display device. The anaglyph system, as practiced in the prior art, depends upon the use of complementary color filters placed in front of each eye. For example a red filter may be placed between the viewers left eye and the viewing device, and a blue filter may be placed between the viewers right eye and the viewing device. After each eye has become accustomed to the particular color bias, and by displaying the left view perspective of the subject in red and the right view perspective in blue, a reasonable stereoscopic image may be observed. However, because each eye is observing a limited portion of the full color spectrum, only limited color information can be seen.

A current technique is to display full color images on a non-interlaced display device using a left image displayed on the odd horizontal lines of the display device and a right image displayed on the even horizontal lines of the display device as disclosed in Applicant″s co-owned U.S. patent application Ser. No. 09/130,938 (now U.S. Pat. No. ______), the contents of which are incorporated herein by reference. The odd lines or even lines are alternately cancelled on each image frame. The screen is viewed through shutter glasses which permit each eye to view only the image of the appropriate perspective. The shutter glasses typically consist of two liquid crystal shutter cells which alternate from dark when electrical power is applied and clear when electrical power is not applied. Each shutter cell becomes clear while the other cell is dark and becomes dark while the other cell is clear. Typical glasses cells alternate between a clear and dark state based on the detection of the vertical retrace refresh signal from a display device.

Standard television systems (NTSC, PAL) refreshes the viewing screen by drawing the odd horizontal lines during a first vertical field and then draws the even horizontal lines the following field, which is known as interlacing or interleaving. Two fields make a complete frame. Due to the relatively quick decay rate of the television screen's phosphorous, a stereoscopic image can be displayed in such a fashion as to have one perspective placed on the odd horizontal lines and the other perspective placed on the even horizontal lines, as disclosed in U.S. Pat. No. 5,821,989. The shutter glasses may then be triggered by the vertical refresh signal to coincide with the display of each field. However, because of the low refresh rate of 50 Hz for PAL or SECAM and 60 Hz for NTSC television images, the viewer perceives substantial flicker as a result of the shutter glass cells alternating at only the field refresh rate. This refresh rate is low enough that a viewer perceives the alternation of the glasses lenses from clear to dark as a flicker of the image. A higher refresh rate on the television monitor would alleviate this flicker to the viewer however this would require a custom or non-standard monitor system operating at a minimum of 120 Hz field rate. At this speed, the flicker is not noticeable, however, television monitors do not operate at this speed and artificially increasing a television monitor to 1 20 Hz may cause damage to the display device or the monitor may not display such images.

Therefore, there is a need in the art for a system of displaying a three-dimensional stereoscopic image on a standard video or television monitor in a flicker-free manner.

### SUMMARY OF INVENTION

The present invention provides a method and apparatus for displaying a stereoscopic image on a standard video or television monitor in a flicker-free manner. The television monitor displays two video fields per video frame where the odd horizontal lines are displayed in the first field and the even horizontal lines are displayed in the second field. The video fields refresh at a rate of 50 Hz or 60 Hz.

In one aspect of the invention, the invention is a method comprising the steps of: (a) combining a right perspective image with a left perspective image in a video frame by dividing each field into an odd number of substantially equal subfields and alternating the right and left perspective images with each subfield as shown in FIG. 1 or FIG. 5; (b) providing shutter glasses which can selectively block either the left eye view or the right eye view of a user;(c)generating a signal marking the end of each subfield and the commencement of the next subfield; and (d) blocking one eye view for the duration of a first subfield and the other eye view for the duration of the next subfield and thereafter alternating between the left eye and right views, coinciding with the commencement of each subfield.

The number of subfields in a field is preferably three such that the right perspective image occurs in the first and third subfields of the first field and the second subfield of the second field and the left perspective image occurs in the second subfield of the first field and the first and third subfields of the second field. A complete composite right/left image is then produced during each video frame. It may be seen the number of subfields must be odd in order for the complete composite image to be displayed during a video frame. Increasing the number of subfields increases the shutter alternation rate. Current liquid crystal glasses technology will only alternate at a rate of about 400 Hz, therefore, this frequency limits the number of subfields that can be provided. If the number of subfields is five per field, then the glasses must alternate at a rate of about 300 Hz in an NTSC system. When the number of subfields is three, the glasses alternate at about 180 Hz, which is sufficient to eliminate any viewer perception of flicker.

In order to trigger the alternation between the left eye view and right eye view of the shutter glasses, the vertical refresh signal is detected and used to initiate a counting sequence which counts the total number of horizontal lines per field. The number of horizontal lines is divided by three such that the shutter glasses alternate at three times the vertical refresh rate. In a preferred embodiment, the trigger signal to the glasses is initiated just before the end of a subfield in the first field and just after the end of a subfield in the second field.

In another aspect of the invention, the invention is an apparatus for displaying a stereoscopic image on a standard video or television monitor in a flicker-free manner. The apparatus is for use with a standard video or television system which displays on a monitor two video fields per video frame where the odd horizontal lines are displayed in the first field and the even horizontal lines are displayed in the second field. It is necessary to feed a composite image to the television monitor which combines a right perspective image with a left perspective image in a number of subfields in the manner described above.

In one embodiment, the apparatus may comprise a: (a) a sync separator which receives the composite video signal displayed on the television monitor and detects the horizontal and vertical refresh signals; (b) a counter operatively connected to the sync separator which counts the horizontal refresh signals, resetting the count to zero with each vertical refresh signal and divides the number of horizontal refresh signals per field by the odd number of subfields per field to generate each subfield; (c) a trigger which receives a signal from the counter and outputs a signal when the end of each subfield is reached; (d) means for alternating the trigger output signal between the right cell and the left cell of a pair of shutter glasses, wherein the shutter glasses cells darken in response to the trigger output signal.

### BRIEF DESCRIPTION OF DRAWINGS

The present invention will be further described with reference to the accompanying drawings. It will be appreciated by the person skilled in the art that other embodiments of the present invention are possible, and therefore the particularity of the accompanying drawings is not to be understood as superseding to the generality of the invention as claimed and described herein.

FIG. 1 shows the pattern of the left and right perspective horizontal display lines placed in the appropriate fields and subfields. The perspective view actually displayed is shown in bold.

FIG. 2 shows the switching pattern of the subfield perspective images over the fields.

FIG. 3 shows the total horizontal lines divided by three which represent the switching signals transmitted to the glasses in each field.

FIG. 4 shows the alternate patterns of the shutter cells on the glasses.

FIG. 5 shows the stereoscopic video format required to see stereoscopic images on the display device.

FIG. 6 shows a schematic representation of an embodiment of the present invention as described herein.

FIG. 7A shows schematically a light/dark band reduction scheme.

FIG. 7B shows progressive base lightening and darkening.

### DETAILED DESCRIPTION

The present invention provides a method and apparatus for displaying a stereoscopic image on a standard video or television monitor in a flicker-free manner. The television monitor displays two video fields per video frame where the odd horizontal lines are displayed in the first field and the even horizontal lines are displayed in the second field. The field (vertical) refresh rate may be either 50 Hz or 60 Hz in conventional television systems. The principle for operation of the present invention is to alternate the left eye and right eye perspective at a rate which is at least three times the rate of vertical refresh of the fields or at least six times the rate of frame refresh.

To accomplish this objective, it is necessary to provide a composite image which has the right eye perspective image and left eye perspective image split on the odd and even horizontal lines of the composite image respectively. In one embodiment, each field is split into three subfields and each subfield is one third of a complete field. The right eye perspective view and left eye perspective view is then alternated between the six subfields of a frame. Therefore, each of the first and second fields may have three subfields where: (a) the first subfield has the right perspective view on the odd horizontal lines and the left perspective view on the even horizontal lines; (b) the second subfield has the left perspective view on the odd horizontal lines and the right perspective view on the even horizontal lines; and (c) the third subfield has the right perspective view on the odd horizontal lines and the left perspective view on the even horizontal lines.

The production of a suitable composite video image is well within the skill of one skilled in the art.

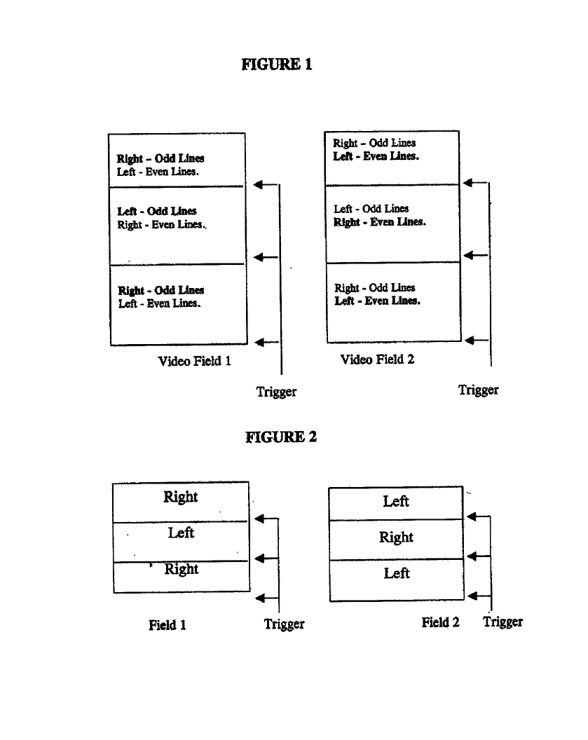

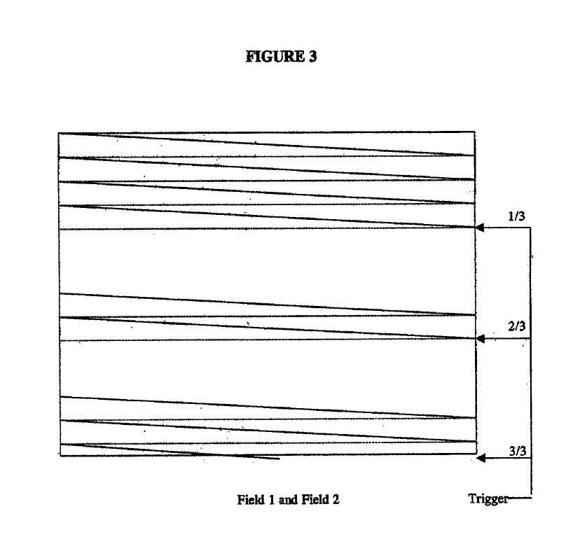

Thus, the images combining the first field and the second field make a correctly formatted complete frame. This composite image is shown schematically in FIG. 1 and FIG. 2. Because only odd horizontal lines are shown in the first field and only even horizontal lines are shown in the second field, this composite image creates an alternating right perspective, left perspective view as shown schematically in FIGS. 2 and 3.

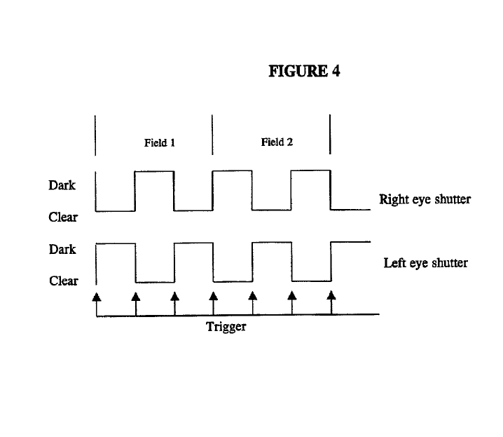

It is then necessary to coordinate the operation of a pair of shutter glasses to the pattern of the composite video image. Conventional LC (liquid crystal) shutter glasses are appropriate for use with this invention. The glasses comprise a left cell and right cell through which a user views the television monitor. When an electric potential is applied to each cell, the cell will darken, obscuring the user's view through that eye. Therefore, as the first subfield of the first field is drawn, the right cell should be clear and the left cell dark. When the next subfield is started, the cells should flip such that the left cell is clear and right cell is dark. The flipping of the left cell and right cell shutters is shown schematically in FIG. 4.

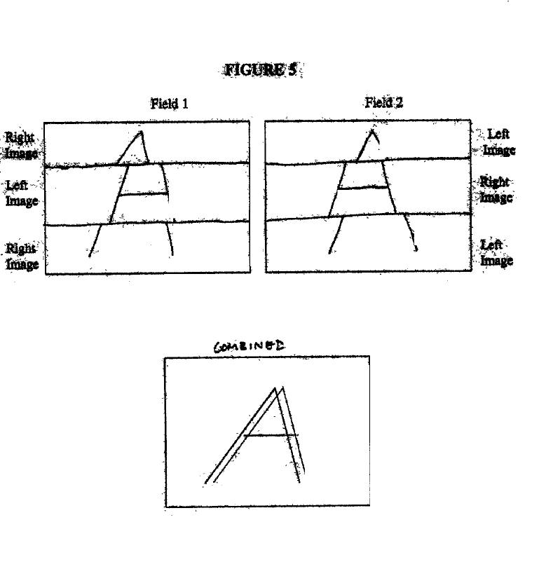

The trigger event to activate the darkening of the left or right cell is the completion of a subfield and the commencement of the next subfield. In one embodiment, this triggering event is created by the use of a sync separator and counter. The composite video signal is connected to a sync separator (10) which may be a LM1881. The sync separator parses the composite video signal and outputs an vertical pulse signal and a horizontal pulse signal to a counter (12). The counter counts the number of horizontal pulse signals in each field. The counter is reset to zero with each vertical pulse signal, which signals the completion of a field and the beginning of the next field. The counter divides the number of horizontal pulses per vertical pulse signal by three to determine the number of horizontal pulses per subfield and to thereby mark the beginning and end of each subfield. This operation is demonstrated schematically in FIG. 5.

The counter (12) is operatively connected to a trigger (14) which outputs a trigger signal when the counter reaches the end of each subfield. The trigger signal is received by a simple flip-flop circuit (16) which alternates the trigger signal between the right cell and left cell of the shutter glasses. The trigger signal may be sent by a wired connection to the shutter glasses driver (18) or a wireless connection. The shutter glasses driver receives the trigger signal and applies it to the appropriate cell.

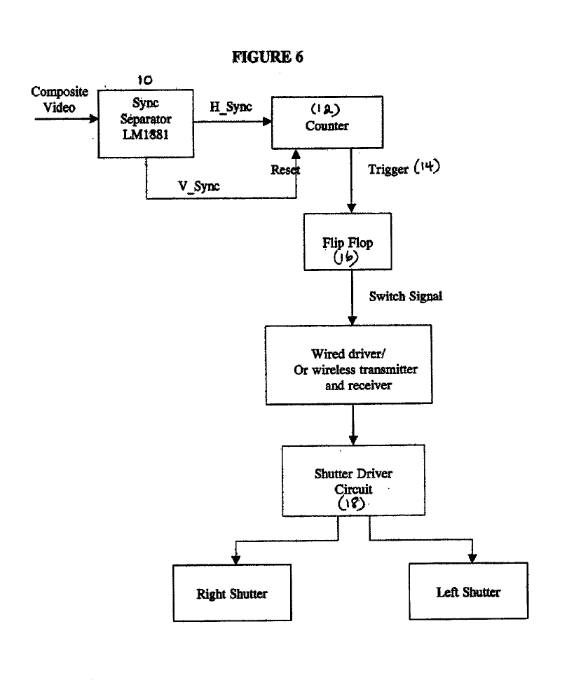

FIG. 6 shows schematically the apparatus of the present invention. The elements of the apparatus may be comprised of programmed microchips to accomplish the functionality described above, as is well-known in the art. Other alternatives include a sequential series of CMOS Flip-Flop chips which can be used to replace the counting functions of the pre-programmed microchips.

In a preferred embodiment, the invention further comprises a means for limiting visible flicker caused by the relatively quick phosphorous decay rate in the television monitor. In one embodiment, this means is a simple clear passive filter placed over glasses cell which slightly scatters visible light. This filter will eliminate further flicker caused by the phosphorous decay rate of the viewing device.

In a further preferred embodiment, the invention further comprises a means for limiting visible artifacts caused by the use of slow liquid crystal cells in the glasses. Due to the relatively slow on and off time of the shutter glasses cells compared to the horizontal line retrace time, visible dark and clear bands across the viewing screen may be evident to a viewer when the cells alternate. If a cell has a quicker on-off response period than the time it takes for the monitor horizontal return time, no apparent artifacts would be evident to the viewer, however current liquid crystal technology prevents such speeds from being attained. In this preferred embodiment, the perception of such artifacts may be limited or eliminated by triggering the cell alternation slightly before the end of a subfield is reached in the first field and slightly after the end of a subfield in the second field. This may be accomplished by counting the number of horizontal lines, dividing by three and reducing this count by 10, which is used to cause the glasses cell to trigger, the first cell triggers 10 horizontal lines earlier than an exact ⅓ of the displayed horizontal lines during the first Field.

By counting the number of horizontal lines, dividing by three and increasing this count by 10, which is used to cause the glasses second cell to trigger, the second cell triggers 10 horizontal lines later than an exact ⅓ of the displayed horizontal lines during the second field. While the combined result eliminates or reduces the viewer's perception of light and dark bands caused by the relatively slow response time of the LC glasses, this technique may still cause the viewer to see a light horizontal band on the display device caused by the first cell turning on. At the same time the viewer may see through the second cell a horizontal dark band on the display device caused by the second cell turning off.

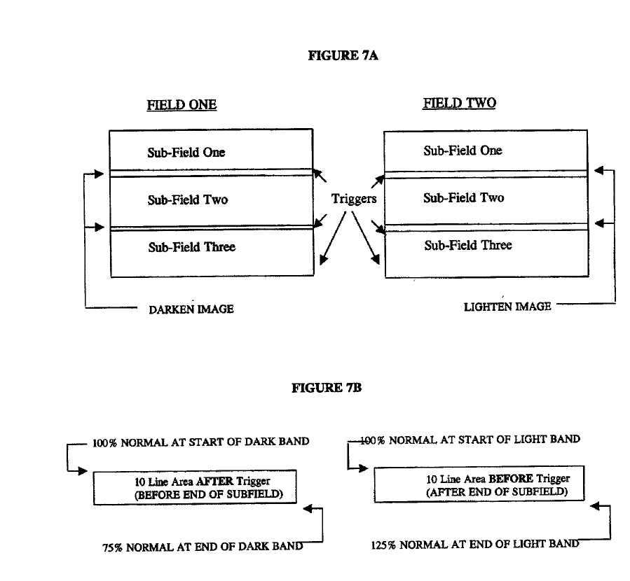

In one embodiment, the composite video signal itself may be manipulated to remove the apparent horizontal light and dark bands visible to the user. The colour intensity of the image in the area of the light horizontal band may be progressively decreased within the transition area. In this case, the transition area is that portion of the image which is drawn during the time period between activation of the trigger and the end of a subfield. Where the trigger is activated 1 0 horizontal retrace lines before the end of each subfield in the first field, the image in that area is progressively darkened. In each second field, the image is lightened, or the colour intensity increased, in a progressive manner, starting with the end of each subfield and ending with the trigger point 10 horizontal lines afterwards. ending with the end of subfield. This method is shown schematically in FIGS. 7A and 7B. FIG. 7A shows the darkening scheme for the first field and the lightening scheme for the second field. FIG. 7B shows the progressive nature of the darkened and lightened image. In this example, the image begins at normal intensity and progressively reaches a light intensity of about 75% of normal by the end of the darkened area or a light intensity of about 125% of normal by the end of the lightened area. In a variation of this embodiment, a second method of decreasing the light and dark bands visible to the user involves increasing the contrast on the perspective image in the area of the dark bands and decreasing the contrast on the perspective image in the area of the light bands.As will be apparent to those skilled in the art, various modifications, adaptations and variations of the foregoing specific disclosure can be made without departing from the scope of the invention claimed herein.

1. A method for displaying an image on a standard interlaced video or television monitor in a flicker-free manner comprising the steps of:
(a) combining a right perspective image with a left perspective image in a video frame by dividing each field into an odd number of substantially equal subfields and alternating the right and left perspective images with each subfield;
(b) providing shutter glasses which can selectively block either the left eye view or the right eye view of a user;
(c) generating a trigger signal marking the end of each subfield and the commencement of the next subfield; and
(d) blocking one eye view for the duration of a first subfield and the other eye view for the duration of the next subfield and thereafter alternating between the left eye and right views, coinciding with the commencement of each subfield.

2. The method of claim 1 wherein each field is divided into three substantially equal subfields.

3. The method of claim 2 wherein the trigger signal is generated just before the end of a subfield in a first field and just after the end of a subfield in a second field.

4. The method of claim 3 wherein the trigger signal is generated about 10 horizontal lines before the end of a subfield in the first field and 10 horizontal lines after the end of a subfield in the second field.

5. The method of claim 3 wherein the light intensity of the video signal is decreased in the band commencing with the trigger signal and ending with the end of the subfield in the first field and increased in the band commencing with the end of a subfield and ending with the trigger signal in the second field.

6. An apparatus for displaying a stereoscopic image on a standard video or television monitor in a flicker-free manner for use with a composite video signal wherein a right and left perspective image are combined in a video frame wherein each field is divided into an odd number of subfields such that the right and left image perspectives are alternated between the subfields, said apparatus comprising:
(a) a sync separator which receives the composite video signal displayed on the television monitor and detects the horizontal and vertical refresh signals;
(b) a counter operatively connected to the sync separator which counts the horizontal refresh signals, resetting the count to zero with each vertical refresh signal and divides the number of horizontal refresh signals per field by the odd number of subfields per field to generate each subfield;
(c) a trigger which receives a signal from the counter and outputs a signal when the end of each subfield is reached;
(d) means for alternating the trigger output signal between the right cell and the left cell of a pair of shutter glasses;
wherein the shutter glasses cells darken in response to the trigger output signal.

7. The apparatus of claim 6 further comprising a pair of shutter glasses operatively connected to the alternation means.

8. The apparatus of claim 6 wherein there are 3 subfields per field.

9. The apparatus of claim 7 further comprising a clear filter attached to the shutter glasses which slightly scatters visible light.
